(19) United States
(12) Patent Application Publication
(10) Pub. No.: US 2025/0194610 A1
(43) Pub. Date: Jun. 19, 2025

(54) Animal Lift Hoist Device

(71) Applicant: William Krisanits, Junction City, LA (US)

(72) Inventor: William Krisanits, Junction City, LA (US)

(21) Appl. No.: 18/641,652

(22) Filed: Apr. 22, 2024

Related U.S. Application Data
(60) Provisional application No. 63/610,054, filed on Dec. 14, 2023.

(51) Int. Cl. A22B 5/06

(52) U.S. Cl. CPC A22B 5/06

(57) ABSTRACT

An animal lift hoist device is provided. The device is designed for suspending animals for dressing or cleaning purposes. The device is comprised of at least one vertical frame member, one arm, one pulley, and one fastener. During use, the device can be removably attached to a tree or other surfaces, wherein the arm can articulate within a 180-degree range and lock at a desired angle. The arm supports at least one pulley, connected to a winch on the vertical frame, facilitating the raising of an animal attached to a hanging device like a gambrel. Additionally, the device can be adapted for attachment to vehicles like ATVs or UTVs, enhancing its utility for single users in field dressing scenarios.

### CROSS-REFERENCE TO RELATED APPLICATION

The present application claims priority to, and the benefit of, U.S. Provisional Application No. 63/610,054, which was filed on Dec. 14, 2023, and is incorporated herein by reference in its entirety.

### FIELD OF THE INVENTION

The present invention relates generally to the field of animal dressing and cleaning. More specifically, the present invention relates to a tree-attachable animal lift hoist device that allows a single user to easily suspend an animal for dressing/cleaning. Accordingly, the present disclosure makes specific reference thereto. Nonetheless, it is to be appreciated that aspects of the present invention are also equally applicable to other like applications, devices, and methods of manufacture.

### BACKGROUND

For many hunters, the process of finding an appropriate cleaning and dressing spot for harvested game animals is not only challenging but can also become a significant source of frustration. This difficulty arises from several factors, including the need to locate a spot that is both accessible and suitable for the tasks of gutting, cleaning, and preparing the animal for transport or consumption.

Additionally, hunters often face the daunting task of handling the sheer size and weight of the game they have successfully harvested. Large game animals, such as deer, elk, or moose, require substantial effort to clean and dress properly. This often necessitates seeking assistance from others, whether it be friends, family members, or fellow hunters, to efficiently and safely manage the animal. The logistics of coordinating such help, especially in remote hunting locations, adds another layer of complexity to the post-harvest process.

Moreover, the challenge of transporting a harvested animal out of the woods, especially when hunting alone, cannot be overstated. The task of hauling a large, intact animal through potentially rugged and dense forest terrain is nearly impossible for a single individual. This situation can be helped by using an ATV, UTV, or other similar vehicle. However, a user must still place the animal onto said vehicle, which can be incredibly difficult to do alone.

Therefore, there exists a long-felt need in the art for a device that improves a user's ability to dress and clean animals. There also exists a long-felt in the art for an animal lift hoist device. More specifically, there exists a long-felt need in the art for an animal lift hoist device that allows a user to suspend an animal in any outdoor location for dressing/cleaning. There also exists a long-felt need in the art for an animal lift hoist device that allows a user to suspend an animal in any outdoor location for dressing/cleaning wherein the device only requires a single user to operate.

The subject matter disclosed and claimed herein, in one embodiment thereof, comprises an animal lift hoist device. The device is designed for suspending animals for dressing or cleaning purposes. The device is comprised of at least one vertical frame member, one arm, one pulley, and one fastener. During use, the device can be removably attached to a tree or other surfaces, wherein the arm can articulate within a 180-degree range and lock at a desired angle. The arm supports at least one pulley, connected to a winch on the vertical frame, facilitating the raising of an animal attached to a hanging device like a gambrel. Additionally, the device can be adapted for attachment to vehicles like ATVs or UTVs, enhancing its utility for single users in field dressing scenarios.

In this manner, the animal lift hoist device of the present invention accomplishes all the foregoing objectives and provides a device that improves a user's ability to dress and clean animals. More specifically, the device allows a user to suspend an animal in any outdoor location for dressing/cleaning. While doing so, the device only requires a single user to operate.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal lift hoist device comprised of at least one vertical frame member, at least one arm, and at least one pulley. The device can be removably attached to a tree or other surface, wherein the device can then be used to suspend an animal for dressing/cleaning. The device is comprised of at least one fastener used to attach the vertical frame member to a tree or other surface. The fastener preferably attaches to the vertical frame member via at least one fastener attachment point.

In one embodiment, the vertical frame member is comprised of at least one horizontal frame member. In this embodiment, at least one arm attaches to the horizontal frame member. In a different embodiment, the arm may attach directly to the vertical frame member. The arm attaches to either frame member in either embodiment via at least one pivot point that allows the arm to articulate.

The arm is comprised of at least one attachment point that allows at least one pulley to attach to the arm. In the preferred embodiment, a first pulley is attached to the attachment point and a second pulley is positioned below the first pulley, wherein both pulleys are connected by at least one rope. The rope is further attached to at least one winch positioned on the vertical frame member. The second pulley may be comprised of at least one fastener that allows at least one hanging device to removably attach to the second pulley. The hanging device may be any style and configuration of hanging structure used to hang an animal for cleaning/dressing.

The present invention is also comprised of a method of using the device. First, a device is provided comprised of a vertical frame member, at least one fastener, at least one winch, at least one pulley, at least one rope, and at least one hanging device. Then, the vertical frame member can be attached to a tree or other surface via the fastener. Then, the pulley can be attached to an attachment point of the arm, wherein the angle of the arm relative to the vertical frame member may be adjusted. Next, the rope can be attached to/around the pulley and winch. Then, the hanging device can be attached to the pulley and an animal can be attached to the hanging device. Finally, the winch can be used to raise the hanging device into the air such that the animal is suspended off the ground.

Accordingly, the animal lift hoist device of the present invention is particularly advantageous as it provides a device that improves a user's ability to dress and clean animals. More specifically, the device allows a user to suspend an animal in any outdoor location for dressing/cleaning. While doing so, the device only requires a single user to operate. In this manner, the animal lift hoist device overcomes the limitations of existing methods and devices used to clean and dress animals.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one potential embodiment of an animal lift hoist device of the present invention in accordance with the disclosed architecture; and

FIG. 2 illustrates a flowchart of a method of using one potential embodiment of an animal lift hoist device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that improves a user's ability to dress and clean animals. There also exists a long-felt in the art for an animal lift hoist device. More specifically, there exists a long-felt need in the art for an animal lift hoist device that allows a user to suspend an animal in any outdoor location for dressing/cleaning. There also exists a long-felt need in the art for an animal lift hoist device that allows a user to suspend an animal in any outdoor location for dressing/cleaning wherein the device only requires a single user to operate.

The present invention, in one exemplary embodiment, is comprised of an animal lift hoist device. The device is comprised of at least one vertical frame member, at least one arm, and at least one pulley. The device can be removably attached to a tree or other surface to suspend an animal for dressing/cleaning. The device is comprised of at least one fastener used to attach the vertical frame member to a tree or other surface. The fastener preferably attaches to the vertical frame member via at least one fastener attachment point.

In one embodiment, the vertical frame member is comprised of at least one horizontal frame member. In this embodiment, at least one arm attaches to the horizontal frame member. In a different embodiment, the arm may attach directly to the vertical frame member. The arm attaches to either frame member in either embodiment via at least one pivot point that allows the arm to articulate.

The arm is comprised of at least one attachment point that allows at least one pulley to attach to the arm. In the preferred embodiment, a first pulley is attached to the attachment point and a second pulley is positioned below the first pulley. Both pulleys are connected by at least one rope that is further attached to at least one winch positioned on the vertical frame member. The second pulley may be comprised of at least one fastener that allows at least one hanging device to removably attach to the second pulley. The hanging device may be any style and configuration of hanging structure used to hang an animal for cleaning/dressing.

The present invention is also comprised of a method of using the device. First, a device is provided comprised of a vertical frame member, at least one fastener, at least one winch, at least one pulley, at least one rope, and at least one hanging device. Then, the vertical frame member can be attached to a tree or other surface via the fastener. Then, the pulley can be attached to an attachment point of the arm, wherein the angle of the arm relative to the vertical frame member may be adjusted. Next, the rope can be attached to/around the pulley and winch. Then, the hanging device can be attached to the pulley and an animal can be attached to the hanging device. Finally, the winch can be used to raise the hanging device into the air such that the animal is suspended off the ground.

Accordingly, the animal lift hoist device of the present invention is particularly advantageous as it provides a device that improves a user's ability to dress and clean animals. More specifically, the device allows a user to suspend an animal in any outdoor location for dressing/cleaning. While doing so, the device only requires a single user to operate. In this manner, the animal lift hoist device overcomes the limitations of existing methods and devices used to clean and dress animals.

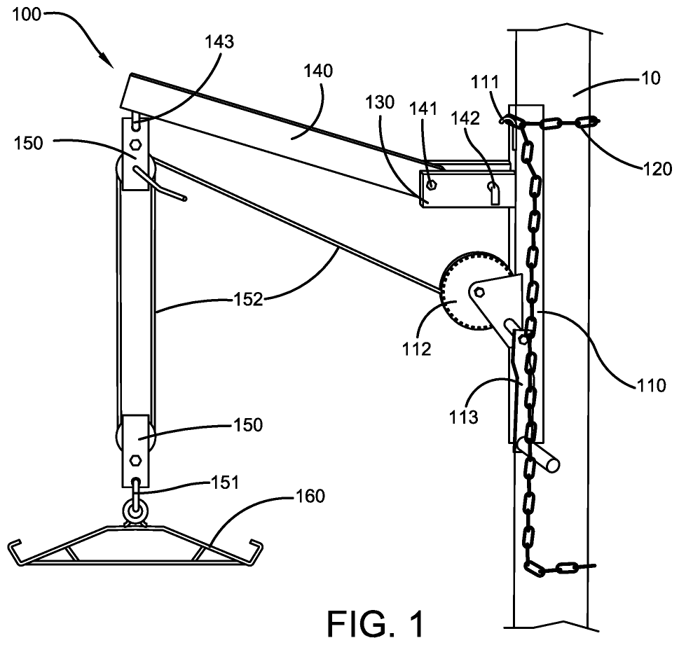

Referring initially to the drawings, FIG. 1 illustrates a side perspective view of one potential embodiment of an animal lift hoist device 100 of the present invention in accordance with the disclosed architecture. The device 100 is comprised of at least one vertical frame member 110, at least one arm 140, and at least one pulley 150. The device 100 can be removably attached to a tree 10 or other surface, wherein the device 100 can then be used to suspend an animal for dressing/cleaning. The device 100 is preferably made from a durable metal material.

The device 100 is comprised of at least one fastener 120. The fastener 120 is used to attach the vertical frame member 110 to a tree 10 or other surface. The fastener 120 is preferably a chain but may be any fastener type such as, but not limited to, a nail, a screw, a bolt, etc. The fastener 120 preferably attaches to the frame member 110 via at least one fastener attachment point 111 such as but not an eyelet, an opening, etc.

In one embodiment, the vertical frame member 110 is comprised of at least one horizontal frame member 130. In this embodiment, at least one arm 140 attaches to the horizontal frame member 130. In a different embodiment, the arm 140 may attach directly to the vertical frame member 110. The arm 140 attaches to either frame member 110, 130 in either embodiment via at least one pivot point 141. The pivot point 141 preferably allows the arm 140 to articulate within a 180-degree range of motion relative to a vertical axis of the vertical frame member 110. The arm 140 can be locked at a desired angle via at least one locking mechanism 142 such as, but not limited to, a locking pin.

The arm 140 is comprised of at least one attachment point 143 that allows at least one pulley 150 to attach to the arm 140. The pulley 150 may be any type of pulley, such as, but not limited to, a locking pulley. In the preferred embodiment, a first pulley 150 is attached to the attachment point 143 and a second pulley 150 is positioned below the first pulley 150, wherein both pulleys are connected by at least one rope 152 of any material. The rope 152 is further attached to at least one winch 112 positioned on the vertical frame member 110. In one embodiment, the winch 112 is an electric winch. In another embodiment, the winch 112 is a manual winch that can be cranked via at least one winch handle 113.

The second pulley 150 may be comprised of at least one fastener 151, such as, but not limited to, a carabiner, which allows at least one hanging device 160 to removably attach to the second pulley 150. The hanging device 160 may be any style and configuration of hanging structure used to hang an animal for cleaning/dressing such as, but not limited to, a gambrel.

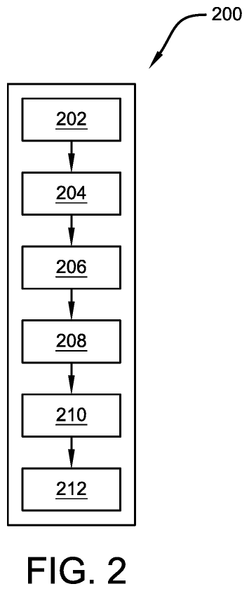

The present invention is also comprised of a method of using 200 the device 100, as seen in FIG. 2. First, a device 100 is provided comprised of a vertical frame member 110, at least one fastener 120, at least one winch 112, at least one pulley 150 (preferably a first and second pulley 150), at least one rope 152, and at least one hanging device 160 [Step 202]. Then, the vertical frame member 110 can be attached to a tree 10 or other surface via the fastener 120 [Step 204]. Then, the first pulley 150 can be attached to an attachment point 143 of the arm 140, wherein the angle of the arm 140 relative to the vertical frame member 110 may be adjusted [Step 206]. Next, the rope 152 can be attached to/around the pulley 150 and winch 112 [Step 208]. Then, the hanging device 160 can be attached to the second pulley 150 and an animal can be attached to the hanging device 160 [Step 210]. Finally, the winch 112 can be used to raise the hanging device 160 into the air such that the animal is suspended off the ground [Step 212].

It should be appreciated that in one embodiment, the vertical frame member 110 can be attached to an ATV, UTV, or other similar vehicle via a fastener 120 such as, but not limited to, a mounting bracket. This configuration allows a singular user to easily load an animal onto said ATV, UTV, etc., and/or field dress an animal.

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “animal lift hoist device” and “device” are interchangeable and refer to the animal lift hoist device 100 of the present invention.

Notwithstanding the foregoing, the animal lift hoist device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the animal lift hoist device 100 as shown in the FIGS. are for illustrative purposes only, and that many other sizes and shapes of the animal lift hoist device 100 are well within the scope of the present disclosure. Although the dimensions of the animal lift hoist device 100 are important design parameters for user convenience, the animal lift hoist device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal lift hoist device comprising:
a vertical frame member;
a first fastener;
an arm attached to the vertical frame member via a pivot point;
a winch;
a pulley; and
a rope.

2. The animal lift hoist device of claim 1 further comprised of a hanging device.

3. The animal lift hoist device of claim 1, wherein the hanging device is comprised of a gambrel.

4. The animal lift hoist device of claim 1, wherein the winch is comprised of a manual winch.

5. The animal lift hoist device of claim 1, wherein the winch is comprised of an electric winch.

6. The animal lift hoist device of claim 1, wherein the arm is comprised of an attachment point that receives the pulley.

7. The animal lift hoist device of claim 1, wherein the pulley is comprised of a second fastener.

8. The animal lift hoist device of claim 7, wherein the second fastener is comprised of a carabiner.

9. The animal lift hoist device of claim 1 further comprised of a locking mechanism.

10. The animal lift hoist device of claim 1, wherein the fastener is comprised of a chain.

11. An animal lift hoist device comprising:
a vertical frame member;
a first fastener;
a horizontal frame member;
an arm attached to the horizontal frame member via a pivot point;
a winch;
a pulley; and
a rope.

12. The animal lift hoist device of claim 11 further comprised of a hanging device comprised of a gambrel.

13. The animal lift hoist device of claim 11, wherein the winch is comprised of a manual winch.

14. The animal lift hoist device of claim 11, wherein the winch is comprised of an electric winch.

15. The animal lift hoist device of claim 11, wherein the arm is comprised of an attachment point that receives the pulley.

16. The animal lift hoist device of claim 11, wherein the pulley is comprised of a carabiner.

17. The animal lift hoist device of claim 11 further comprised of a locking mechanism.

18. The animal lift hoist device of claim 11, wherein the fastener is comprised of a chain.

19. A method of using an animal lift hoist device, the method comprising the following steps:
providing an animal lift hoist device comprised of a vertical frame member, a fastener, a winch, a first pulley, second pulley, a rope, and a hanging device;
attaching the vertical member to a tree or a surface via the fastener,
attaching the first pulley to an attachment point of the arm and adjusting an angle of the arm;
attaching the rope around the pulley and the winch;
attaching the hanging device to the second pulley and attaching an animal to the hanging device; and
using the winch to raise the hanging device to suspend the animal.

20. The method of using an animal lift hoist device of claim 19, wherein the winch is comprised of an electric winch or a manual winch.
